(19) United States
(12) Patent Application Publication
(10) Pub. No.: US 2022/0289274 A1
(43) Pub. Date: Sep. 15, 2022

(54) ELECTRIC POWER STEERING APPARATUS, CONTROL DEVICE USED IN ELECTRIC POWER STEERING APPARATUS, AND CONTROL METHOD

(71) Applicant: Nidec Corporation, Kyoto (JP)

(72) Inventors: Shuji ENDO, Kyoto (JP); Hiroyuki ISHIMURA, Kawasaki-shi (JP); Hiroki MORITA, Kawasaki-shi (JP)

(21) Appl. No.: 17/632,325

(22) PCT Filed: Aug. 6, 2020
(86) PCT No.: PCT/JP2020/030253

§ 371 Date: Feb. 2, 2022

(30) Foreign Application Priority Data
Aug. 9, 2019 (JP) 2019-147870

(51) Int. Cl. B62D 5/04; B62D 15/02

(52) U.S. Cl. CPC B62D 5/0463; B62D 15/0215

(57) ABSTRACT

A control device includes a processor and a memory that stores a program controlling an operation of the processor to cause the processor to acquire a steering torque, a vehicle speed, a steering angle, and a rotational speed of a motor, generate a base assist torque based on the steering torque and the vehicle speed, generate a self-aligning torque compensation torque based on the steering torque, the vehicle speed, the rotational speed of the motor, and the base assist torque, generate an active return torque based on the vehicle speed and the steering angle, generate a motor loss torque compensation torque based on the rotational speed of the motor, and generate a torque command value to be used to control driving of the motor.

### CROSS-REFERENCE TO RELATED APPLICATIONS

This is a U.S. national stage of application No. PCT/JP2020/030253, filed on Aug. 6, 2020, with priority under 35 U.S.C. § 119(a) and 35 U.S.C. § 365(b) being claimed from Japanese Patent Application No. 2019-147870, filed on Aug. 9, 2019, the entire disclosures of which are hereby incorporated herein by reference.

### 1. FIELD OF THE INVENTION

The present disclosure relates to an electric power steering apparatus, a control device used in the electric power steering apparatus, and a control method.

### 2. BACKGROUND

A general automobile is mounted with an electric power steering apparatus (EPS) including an electric motor (hereinafter, referred to simply as a “motor”). The electric power steering apparatus assists a driver's steering wheel operation by driving the motor. A technique for compensating for a steering feeling in an on-center region by return control of a steering wheel in accordance with a steering angle has been proposed. The on-center region mainly means a steering region where the steering wheel is not substantially turned in a state where a vehicle is traveling straight. Hereinafter, the return control of the steering wheel is referred to as “active return”. Conventionally, techniques for compensating for a desired steering characteristic in an on-center region by imparting a pseudo self-aligning torque (SAT) by active return are known.

There is a demand for improvement of the steering feeling in the on-center region.

### SUMMARY

An example embodiment of a control device of the present disclosure is usable in an electric power steering apparatus including a motor and a deceleration gear and is configured or programmed to control driving of the motor. The control device includes a processor and a memory that stores a program to control an operation of the processor to cause the processor to acquire a steering torque detected by a steering torque sensor, a vehicle speed detected by a vehicle speed sensor, a steering angle detected by a steering angle sensor, and a rotational speed of the motor, generate a base assist torque based on the steering torque and the vehicle speed, generate a self-aligning torque compensation torque based on the steering torque, the vehicle speed, the rotational speed of the motor, and the base assist torque, generate an active return torque based on the vehicle speed and the steering angle, generate a motor loss torque compensation torque based on the rotational speed of the motor, and generate a torque command value to control driving of the motor based on the base assist torque, the self-aligning torque compensation torque, the active return torque, and the motor loss torque compensation torque.

An example embodiment of a control method of the present disclosure is a control method of an electric power steering apparatus including a motor and a deceleration gear, to control driving of the motor. The control method includes acquiring a steering torque detected by a steering torque sensor, a vehicle speed detected by a vehicle speed sensor, a steering angle detected by a steering angle sensor, and a rotational speed of the motor, generating a base assist torque based on the steering torque and the vehicle speed, generating a self-aligning torque compensation torque based on the steering torque, the vehicle speed, the rotational speed of the motor, and the base assist torque, generating an active return torque based on the vehicle speed and the steering angle, generating a motor loss torque compensation torque based on the rotational speed of the motor, and generating a torque command value to control driving of the motor based on the base assist torque, the self-aligning torque compensation torque, the active return torque, and the motor loss torque compensation torque.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 schematically illustrates a configuration example of an electric power steering apparatus 1000 according an example embodiment of the present disclosure.

FIG. 2 is a block diagram illustrating a configuration example of a control device 100 according to the present example embodiment.

FIG. 3 is a functional block diagram illustrating, on a functional block basis, functions of a processor 200 according to the present example embodiment.

FIG. 4 is a functional block diagram describing functions of an SAT compensator 220 according to an example embodiment of the present disclosure.

FIG. 5 is a functional block diagram describing functions of an SAT estimator 221 in the SAT compensator 220.

FIG. 6 is a functional block diagram describing functions of an active returner 230 according to an example embodiment of the present disclosure.

FIG. 7 is a functional block diagram describing functions of a loss torque compensator 240 according to an example embodiment of the present disclosure.

FIG. 8 is a graph illustrating motor torque characteristics describing motor loss torque compensation according to an example embodiment of the present disclosure.

FIG. 9 is a graph illustrating waveforms of steering characteristics as simulation results in accordance with an example embodiment of the present disclosure.

FIG. 10 is a graph illustrating steering characteristics of a general electric power steering apparatus in accordance with an example embodiment of the present disclosure, particularly in an on-center region.

### DETAILED DESCRIPTION

When a vehicle travels straight, a driver does not turn a steering wheel substantially. In a state where steering is in an on-center region, a friction feeling between the vehicle and a road surface disappears, so that it is difficult for the driver to recognize a straight traveling state. For example, there may be a problem in steering stability such as wobbling of the vehicle only by slightly turning the steering wheel. Therefore, the driver can recognize the on-center region by appropriately generating the friction feeling between the vehicle and the road surface.

As described above, in the related art, a desired steering characteristic in the on-center region is compensated by applying a pseudo self-aligning torque by active return. However, only with the active return, an appropriate friction feeling disappears in a state where the steering wheel is positioned near the center (hereinafter, referred to as a steering wheel center). Rather, an artificial feeling given to the driver strengthens the sense of being controlled by an apparatus.

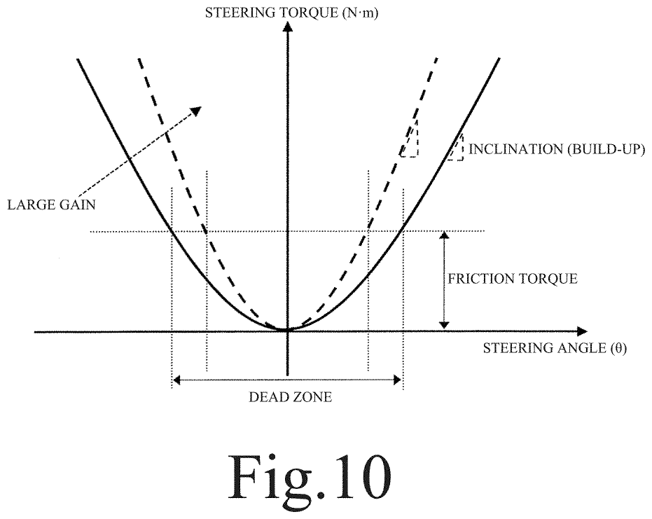

FIG. 10 illustrates steering characteristics of a general electric power steering apparatus, particularly in the on-center region. The horizontal axis represents a steering angle (deg), and the vertical axis represents a steering torque (Nm). A range of the steering angle in which the steering torque is smaller than a friction torque is generally referred to as a dead zone or hysteresis width, and an inclination at which the steering torque rises is referred to as a build-up. As a gain of self-aligning torque compensation, which will be described later, is increased, an inclination of a curve becomes steep, and as a result, a steering characteristic that the steering torque sharply rises is obtained. As a result, the build-up becomes steeper, and the dead zone becomes narrower.

A steering feeling in the on-center region depends on the locus of the curve of the steering characteristic, and is deeply related to the degree of rising of the steering torque when the steering wheel is turned from the steering wheel center, that is, the build-up. In general, it can be said that the steering feeling exists when the steering torque sharply rises in accordance with the steering angle. The narrower the dead zone, the easier a driver feels a straight traveling characteristic of the vehicle. It is desirable to provide steering characteristics that the hysteresis width is small, the friction feeling is appropriate, and the torque build-up has a linear characteristic with respect to the steering angle. According to studies of the present inventor, as target numerical values, it is preferable that the torque build-up be about 0.2 N·m/deg, the hysteresis width be about ±3 deg, and the friction feeling be 1.3 N·m or less.

Based on the above findings, the present inventor has found that a natural steering feeling can be realized by appropriately utilizing three functions of self-aligning torque compensation, active return, and motor loss torque compensation, and has completed the present disclosure.

With reference to the accompanying drawings, hereinafter, a specific description will be given of a control device and a control method for an electric power steering apparatus according to an example embodiment of the present disclosure as well as an electric power steering apparatus including the control device. However, a specific description more than necessary will not be given in some cases. For example, detailed descriptions of well-known matters and duplicate description of substantially the same configuration may be omitted. This is because of avoiding the following description redundant more than necessary and facilitating the understanding of a person skilled in the art.

The following example embodiments are illustrative, and the control device and the control method for an electric power steering apparatus according to the present disclosure are not limited to the following example embodiments. For example, the numerical values, the steps, the order of the steps, and the like illustrated in the following example embodiments are only illustrative, and various modifications can be made unless any technical inconsistency occurs. The example embodiments to be described below are illustrative, and various combinations are possible unless any technical inconsistency occurs.

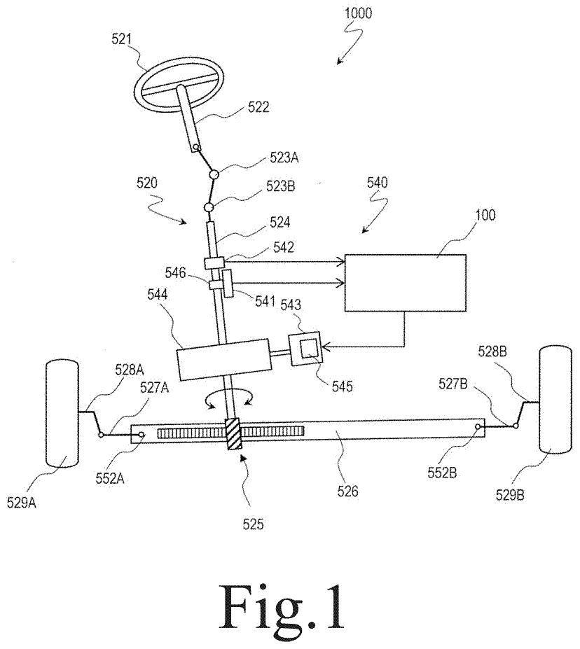

FIG. 1 is a diagram schematically illustrates a configuration example of an electric power steering apparatus 1000 according to the present example embodiment.

The electric power steering apparatus 1000 (hereinafter, referred to as an “EPS”) includes a steering system 520 and an assist torque mechanism 540 which generates an assist torque. The EPS 1000 generates the assist torque for assisting the steering torque of the steering system generated when a driver operates a steering wheel. The assist torque reduces an operation load on the driver.

The steering system 520 includes, for example, a steering wheel 521, a steering shaft 522, universal joints 523A and 523B, a rotating shaft 524, a rack and pinion mechanism 525, a rack shaft 526, left and right ball joints 552A and 552B, tie rods 527A and 527B, knuckles 528A and 528B, and left and right steered wheels 529A and 529B.

The assist torque mechanism 540 includes a steering torque sensor 541, a steering angle sensor 542, an electronic control unit (ECU) 100 for automobiles, a motor 543, a deceleration gear 544, an inverter 545, and a torsion bar 546, for example. The steering torque sensor 541 detects a steering torque in the steering system 520 by detecting the amount of torsion of the torsion bar 546. The steering angle sensor 542 detects a steering angle of the steering wheel.

The ECU 100 generates a motor driving signal based on the detection signals detected by the steering torque sensor 541, the steering angle sensor 542, a vehicle speed sensor (not illustrated) mounted on a vehicle, or the like, and outputs the motor driving signal to the inverter 545. For example, the inverter 545 converts direct-current power into three-phase alternating-current power having A-phase, B-phase, and C-phase pseudo sine waves in accordance with the motor driving signal and supplies the power to the motor 543. The motor 543 is, for example, a surface permanent-magnet synchronous motor (SPMSM) or a switched reluctance motor (SRM), and is supplied with the three-phase alternating-current power to generate an assist torque corresponding to the steering torque. The motor 543 transmits the generated assist torque to the steering system 520 via the deceleration gear 544. Hereinafter, the ECU 100 will be referred to as a control device 100 for the EPS.

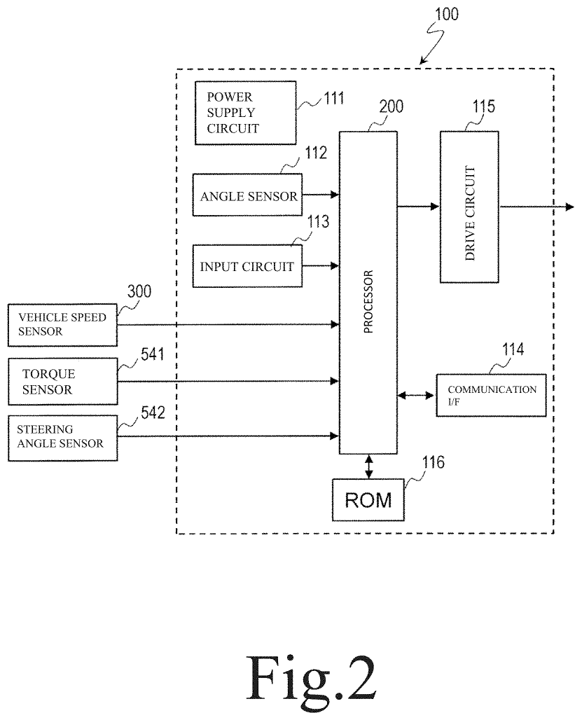

FIG. 2 is a block diagram illustrating a typical example of a configuration of the control device 100 according to the present example embodiment. The control device 100 includes a power supply circuit 111, an angle sensor 112, an input circuit 113, a communication I/F 114, a drive circuit 115, a ROM 116, and a processor 200, for example. The control device 100 can be realized as a printed circuit board (PCB) on which these electronic components are implemented.

A vehicle speed sensor 300 mounted on the vehicle, the steering torque sensor 541, and the steering angle sensor 542 are electrically connected to the processor 200. The vehicle speed sensor 300, the steering torque sensor 541, and the steering angle sensor 542 transmit a vehicle speed v, a steering torque Tₜₒᵣ, and a steering angle θ to the processor 200, respectively.

The control device 100 is electrically connected to the inverter 545. The control device 100 controls switching operations of a plurality of switch elements (for example, MOSFETs) included in the inverter 545. Specifically, the control device 100 generates control signals (hereinafter referred to as “gate control signals”) for controlling the switching operations of the respective switch elements and outputs the gate control signals to the inverter 545.

The control device 100 generates a torque command value based on the vehicle speed v, the steering torque Tₜₒᵣ, and a steering angle θ, and the like, and controls a torque and a rotational speed of the motor 543 by, for example, vector control. The control device 100 can perform not only the vector control but also other closed-loop control. The rotational speed is expressed by the number of revolutions (rpm) at which a rotor rotates per unit time (for example, one minute) or the number of revolutions (rps) at which the rotor rotates per unit time (for example, one second). The vector control is a method in which current flowing through the motor is separated into a current component that contributes to generation of a torque and a current component that contributes to generation of a magnetic flux, and the current components orthogonal to each other are independently controlled.

The power supply circuit 111 is connected to an external power supply (not illustrated) and generates a DC voltage (for example, 3 V or 5 V) required for each block in the circuit.

The angle sensor 112 is, for example, a resolver or a Hall IC. Alternatively, the angle sensor 112 is also realized by a combination of an MR sensor having a magnetoresistive (MR) element and a sensor magnet. The angle sensor 112 detects the rotation angle of the rotor and outputs the rotation angle of the rotor to the processor 200. The control device 100 may include a speed sensor and an acceleration sensor for detecting the rotational speed and acceleration of the motor instead of the angle sensor 112.

The input circuit 113 receives a motor current value (hereinafter, referred to as an “actual current value”) detected by a current sensor (not illustrated), converts a level of the actual current value into an input level for the processor 200 as needed, and outputs the actual current value to the processor 200. A typical example of the input circuit 113 is an analog-digital conversion circuit.

The processor 200 is a semiconductor integrated circuit and is also referred to as a central processing unit (CPU) or a microprocessor. The processor 200 sequentially executes a computer program which is stored in the ROM 116 and describes a command set for controlling motor driving, and realizes desired processing. The processor 200 is widely interpreted as a term including a Field Programmable Gate Array (FPGA), an Application Specific Integrated Circuit (ASIC), or an Application Specific Standard Product (ASSP) equipped with a CPU. The processor 200 sets a target current value in accordance with, for example, the actual current value and the rotation angle of the rotor to generate a PWM signal, and outputs the PWM signal to the drive circuit 115.

The communication I/F 114 is an input/output interface configured to transmit and receive data in conformity with an in-vehicle control area network (CAN), for example.

The drive circuit 115 is typically a gate driver (or a pre-driver). The drive circuit 115 generates a gate control signal in accordance with the PWM signal and gives the gate control signal to gates of the plurality of switch elements included in the inverter 545. There is a case where a gate driver is not necessarily required when a driving target is a motor that can be driven at a low voltage. In this case, the processor 200 may have the function of the gate driver.

The ROM 116 is electrically connected to the processor 200. The ROM 116 is a writable memory (for example, a PROM), a rewritable memory (for example, a flash memory or an EEPROM), or a read-only memory, for example. The ROM 116 stores a control program including a command set for causing the processor 200 to control motor driving. For example, the control program is temporarily expanded in a RAM (not illustrated) at the time of booting.

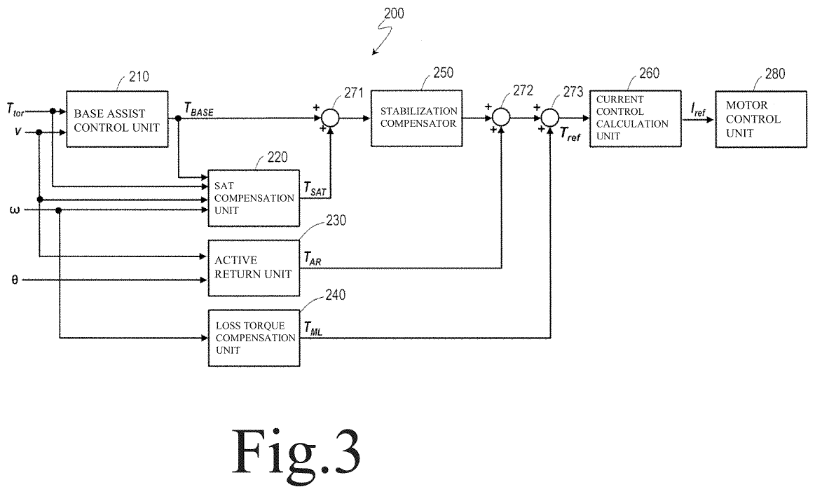

FIG. 3 is a functional block diagram illustrating functions implemented in the processor 200 in functional block units. In the present specification, the processor 200 includes a base assist control unit 210, an SAT compensator 220, an active returner 230, a loss torque compensator 240, a stabilization compensator 250, a current control calculation unit 260, three adders 271, 272, and 273, and a motor control unit 280. Typically, the processes (or the tasks) of the functional blocks corresponding to the respective units are described in the computer program on a software module basis, and are stored in the ROM 116. However, in a case where an FPGA or the like is used, all or some of the functional blocks may be implemented as hardware accelerators.

In a case in which each functional block is implemented as software (or firmware) in the control device 100, a device that executes the software may be the processor 200. In one aspect, the control device according to the present disclosure includes the processor and a memory that stores a program that controls the operation of the processor. The processor executes the following processing in accordance with the program.

(1) A steering torque detected by the steering torque sensor, a vehicle speed detected by the vehicle speed sensor, a steering angle detected by the steering angle sensor, and a rotational speed of the motor are acquired.

(2) A base assist torque is generated based on the steering torque and the vehicle speed.

(3) A self-aligning torque compensation torque is generated based on the steering torque, the vehicle speed, the rotational speed of the motor, and the base assist torque.

(4) An active return torque is generated based on the vehicle speed and the steering angle.

(5) A motor loss torque compensation torque is generated based on the rotational speed of the motor.

(6) A torque command value to be used to control driving of the motor is generated based on the base assist torque, the self-aligning torque compensation torque, the active return torque, and the motor loss torque compensation torque.

(7) A current command value is generated based on the torque command value, and the driving of the motor is controlled based on the current command value.

In a case where each functional block is implemented as software and/or hardware in the control device 100, in another aspect, a control device of the present disclosure includes: a base assist control unit that generates a base assist torque based on a steering torque and a vehicle speed; an SAT compensator that generates a self-aligning torque compensation torque based on the steering torque, the vehicle speed, a rotational speed of a motor, and the base assist torque; an active returner that generates an active return torque based on the vehicle speed and a steering angle; a loss torque compensator that generates a motor loss torque compensation torque based on the rotational speed of the motor; a current control calculation unit that generates a current command value in accordance with a torque command value generated based on the base assist torque, the self-aligning torque compensation torque, the active return torque, and the motor loss torque compensation torque; and a motor control unit that controls driving of the motor based on the current command value.

The processor 200 acquires, as inputs, the steering torque Tₜₒᵣ detected by the steering torque sensor 541, the vehicle speed v detected by the vehicle speed sensor, the steering angle θ detected by the steering angle sensor, and a rotational speed ω of the motor. For example, in a case where the control device 100 includes a speed sensor that detects a rotational speed of the motor, the processor 200 can acquire the rotational speed ω of the motor by acquiring the detected rotational speed from the speed sensor. In a case where the control device 100 includes an angle sensor that detects a rotation angle (more specifically, a mechanical angle) of the rotor, the processor 200 can acquire the rotational speed ω by acquiring the detected rotation angle of the rotor from the angle sensor and calculating an angular speed based on the rotation angle of the rotor.

The base assist control unit 210 acquires the steering torque Tₜₒᵣ and the vehicle speed v as inputs, and generates and outputs a base assist torque T_{BASE} based on the signals. A typical example of the base assist control unit 210 is a table (so-called lookup table) that defines a correspondence between the steering torque Tₜₒᵣ, the vehicle speed v, and the base assist torque T_{BASE}. The base assist control unit 210 determines the base assist torque T_{BASE}, based on the steering torque Tₜₒᵣ and the vehicle speed v.

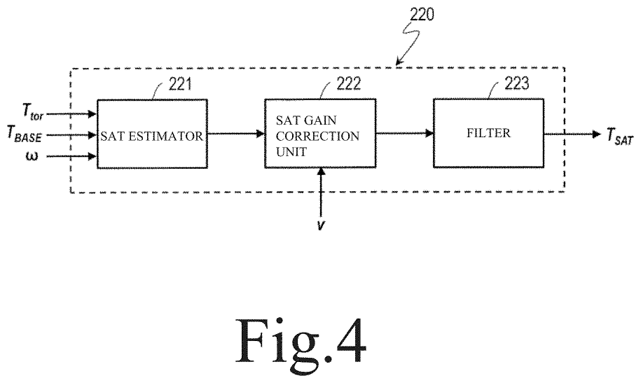

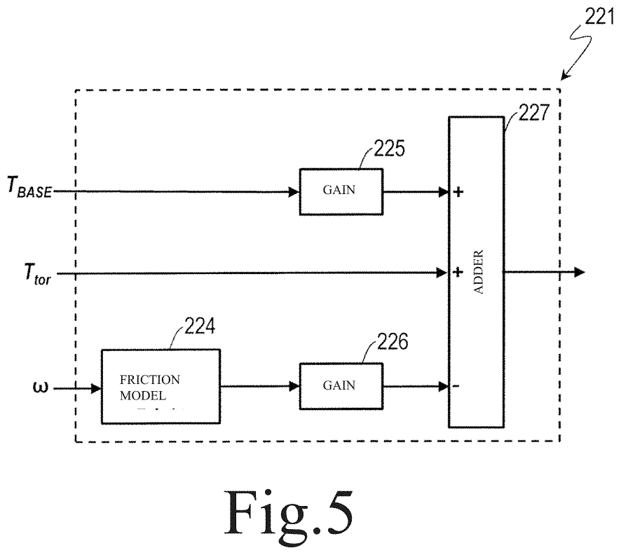

FIG. 4 illustrates functional blocks for describing functions of the SAT compensator 220. FIG. 5 illustrates functional blocks for describing functions of the SAT estimator 221 in the SAT compensator 220. The SAT compensator 220 acquires the steering torque Tₜₒᵣ, the vehicle speed v, the rotational speed ω of the motor, and the base assist torque T_{BASE} as inputs, and generates and outputs the self-aligning torque compensation torque I_{SAT} based on these signals.

The SAT compensator 220 compensates for a static gain of a self-aligning torque. As a result, it is possible to improve a width of a dead zone and a build-up in an on-center region while maintaining a friction feeling.

The self-aligning torque is estimated from the balance of static forces around the steering wheel shaft between the base assist torque T_{BASE} and the steering torque Tₜₒᵣ. As a result, the estimated self-aligning torque includes not only the self-aligning torque compensation torque T_{SAT} but also friction in the estimation result. Therefore, the SAT compensator 220 according to the present example embodiment applies a friction model to SAT compensation to reduce the influence of friction on the estimation result.

The SAT compensator 220 includes the SAT estimator 221, an SAT gain correction unit 222, and a filter 223. The SAT estimator 221 acquires the steering torque Tₜₒr, the base assist torque T_{BASE}, and the rotational speed ω of the motor as inputs, and estimates the self-aligning torque based on these signals. The SAT estimator 221 includes a friction model 224, gains (or control gains) 225 and 226, and an adder 227. The SAT estimator 221 refers to a table that defines a correspondence between the friction torque and the rotational speed of the motor, and determines the steering torque Tₜₒᵣ based on the rotational speed co of the motor.

The friction model 224 is determined based on, for example, a Coulomb friction model. A friction torque T_{fric} is calculated based on the rotational speed ω of the motor using the friction model 224. The gain 225 is a gear ratio g_{c} of the deceleration gear 544, and the gain 226 is a friction gain. The adder 227 calculates an estimated value of the self-aligning torque based on the following Formula 1. The term of T_{fric} on the right side of Formula 1 includes the friction gain. When the term of T_{fric} is subtracted from the right side of Formula 1, the influence of friction on the estimation result is reduced.

T_{SAT}=Tₜₒᵣ+g_{c}*T_{BASE}−T_{fric} <Formula 1>

A typical example of the SAT gain correction unit 222 is a reference table that defines a correspondence between the vehicle speed v and a gain gₛ. In the present example embodiment, the gain gₛ relative to the estimated value of the self-aligning torque is changed in accordance with the vehicle speed v. The SAT gain correction unit 222 refers to a table that defines a correspondence between the gain and the vehicle speed relative to the estimated value of the self-aligning torque, and determines the gain gₛ relative to the estimated value of the self-aligning torque based on the vehicle speed v. The SAT gain correction unit 222 further multiplies the estimated self-aligning torque by the gain gₛ to correct the self-aligning torque in accordance with the vehicle speed v, thereby generating the corrected self-aligning torque.

The filter 223, for example, applies first-order phase lag compensation to the estimated self-aligning torque to generate the self-aligning torque compensation torque T_{SAT}. An example of the filter 223 is a first-order infinite impulse response (IIR) digital filter. When the rotational speed ω of the motor is near zero, chattering may occur in the self-aligning torque that is the estimation result of the SAT estimator 221. When the first-order phase lag compensation is applied by the filter 223, the chattering can be appropriately suppressed.

As described above, the SAT compensator 220 can change the strength of SAT compensation by adjusting each control gain. It should be noted that steering becomes heavy near a steering wheel center since a pseudo self-aligning torque is likely to be excessively increased if the control gain is excessively increased.

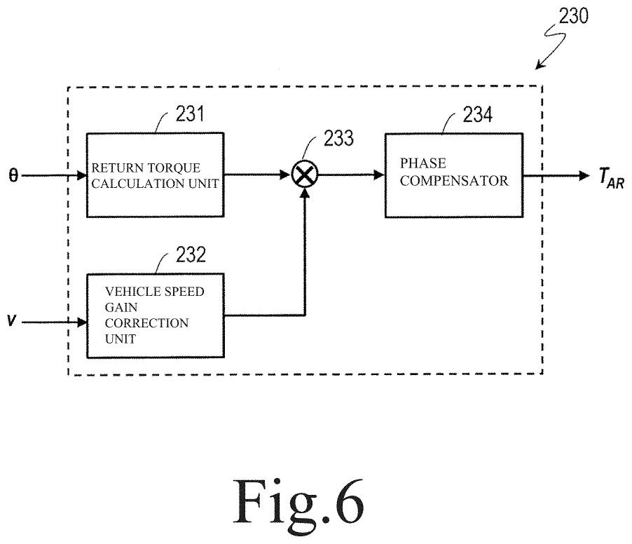

FIG. 6 illustrates functional blocks for describing functions of the active returner 230. The active returner 230 acquires the vehicle speed v and the steering angle θ as inputs, and generates an active return torque T_{AR} based on these. The active returner 230 includes a return torque calculation unit 231, a vehicle speed gain correction unit 232, a multiplier 233, and a phase compensator 234. The return torque calculation unit 231 is a table that defines a correspondence between the steering angle and the active return torque (return torque), and the return torque calculation unit 231 determines the active return torque in accordance with the steering angle. The vehicle speed gain correction unit 232 is a table that defines a correspondence between the vehicle speed and a gain gₐ relative to the active return torque. The vehicle speed gain correction unit 232 determines the gain gₐ in accordance with the vehicle speed v. The multiplier 233 multiplies the active return torque determined by the active returner 230 and the gain gₐ determined by the vehicle speed gain correction unit 232. The phase compensator 234 generates the active return torque T_{AR} by applying phase lag compensation or phase lead compensation to a result of the multiplication by the multiplier 233.

The active returner 230 can improve the build-up by applying the pseudo self-aligning torque in accordance with the steering angle. It should be noted that an artificial steering feeling is likely to be generated since the return (active return) of the steering wheel becomes too strong if the control gain is excessively increased, which is similar to the SAT compensation.

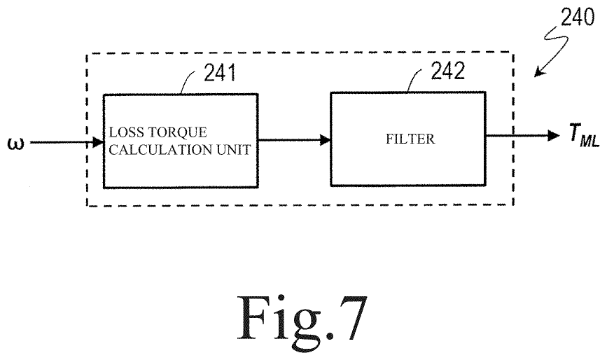

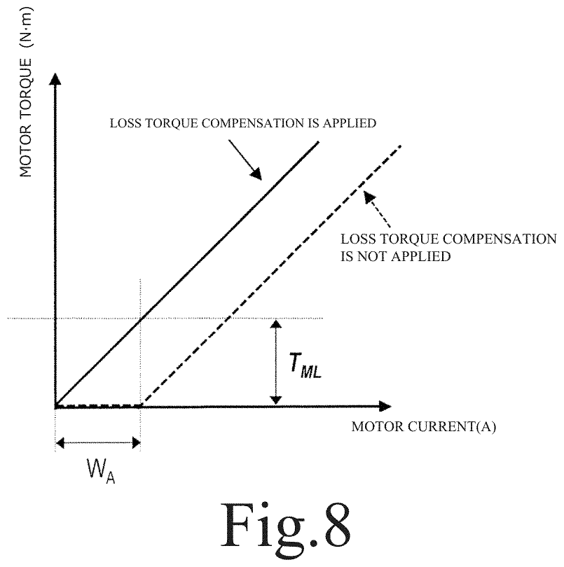

FIG. 7 illustrates functional blocks for describing functions of the loss torque compensator 240. FIG. 8 illustrates motor torque characteristics for describing the motor loss torque compensation. The loss torque compensator 240 generates a motor loss torque compensation torque T_{ML} based on the rotational speed ω of the motor. The loss torque compensator 240 refers to a table that defines a correspondence between a loss torque of the motor and the rotational speed of the motor, determines the loss torque of the motor based on the rotational speed ω of the motor, and applies first-order phase lag compensation to the determined loss torque of the motor, thereby generating the motor loss torque compensation torque T_{ML}.

The loss torque compensator 240 includes a loss torque calculation unit 241 and a filter 242. Here, the motor loss torque compensation will be described with reference to FIG. 8. The horizontal axis represents a motor current (A), and the vertical axis represents a motor torque (N·m). A broken line in the drawing indicates the motor torque characteristic with respect to the motor current in a case where the loss torque compensation is not applied. A solid line in the drawing indicates the motor torque characteristic with respect to the motor current in a case where the loss torque compensation is applied. For example, there is a motor current range WA in which no torque is generated even when the current flows through the motor due to an attractive force of a permanent magnet arranged in the rotor. In the present example embodiment, the loss torque compensation is adopted in order to compensate for a torque loss in the motor current range WA. More specifically, the loss torque calculation unit 241 determines a loss torque compensation torque for performing the loss torque compensation in accordance with the rotational speed ω of the motor. The loss torque calculation unit 241 is a table that defines a correspondence between the rotational speed of the motor and the torque for performing the loss torque compensation. The table is determined based on, for example, a Coulomb friction model.

The filter 242 generates the loss torque compensation torque T_{ML} by applying the first-order phase lag compensation to the determined loss torque compensation torque of the motor. An example of the filter 242 is a first-order IIR digital filter similarly to the filter 223. When a general low-pass filter is used as the filter 242, a high-frequency component included in the loss torque compensation torque T_{ML} is removed, but a phase lag may occur, and as a result, a lag is likely to occur in the power assist of the EPS. On the other hand, when the first-order IIR filter is adopted as the filter 242, chattering of a loss torque compensation torque signal output from the loss torque calculation unit 241 can be suppressed, and the normal power assist can be performed while avoiding the phase lag.

The loss torque calculation unit 241 can improve responsiveness to a minute torque instruction by compensating for the loss torque of the motor. As a result, the friction feeling of the steering at the steering wheel center is improved.

FIG. 3 is referred to again.

The adder 271 adds the self-aligning torque compensation torque T_{SAT}, which is the output from the SAT compensator 220, to the base assist torque T_{BASE} which is the output from the base assist control unit 210.

A torque command value T_{ref} is generated based on the base assist torque T_{BASE}, the self-aligning torque compensation torque T_{SAT}, the active return torque T_{AR}, and the motor loss torque compensation torque T_{ML}. For example, the stabilization compensator 250 applies phase lag compensation or phase lead compensation to an addition value obtained by the adder 271 to generate a stabilization compensation torque. The adder 272 adds the active return torque T_{AR} output from the active returner 230 to the stabilization compensation torque output from the stabilization compensator 250. The adder 273 adds the loss torque compensation torque T_{ML} output from the loss torque compensator 240 to an addition value obtained by the adder 272, thereby generating the torque command value T_{ref} to be used to control driving of the motor. The stabilization compensator 250 may receive one of or both the output from the adder 272 and the output from the adder 273, as in the output from the adder 271.

The current control calculation unit 260 generates a current command value I_{ref} based on the torque command value T_{ref}. The motor control unit 280 sets a target current value based on the current command value I_{ref} by vector control, for example, to generate a PWM signal and outputs the PWM signal to the drive circuit 115.

According to the present example embodiment, a natural steering feeling can be realized by utilizing three functions of the SAT compensation, the active return, and the motor loss torque compensation so as to complement each other. Specifically, the natural steering feeling can be realized by creating, to some extent, steering characteristics with which the natural steering feeling can be obtained in the on-center region by the SAT compensation and finely adjusting the steering characteristics in a direction in which the hysteresis width decreases by the active return. Furthermore, the responsiveness to the minute torque instruction is improved by the loss torque compensation, whereby it is possible to realize a more natural steering feeling.

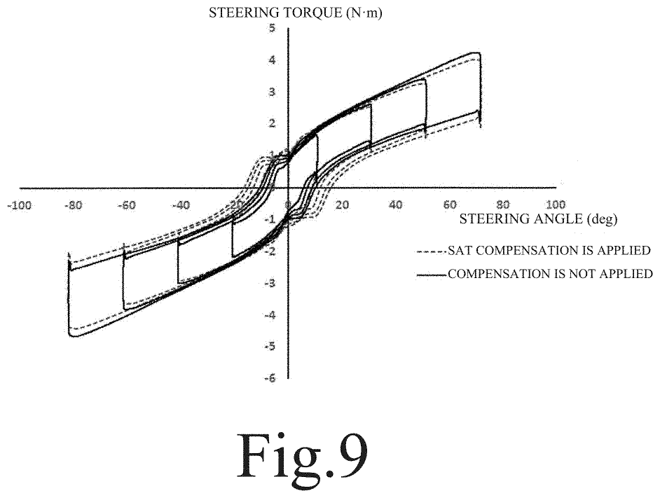

The inventor of the present disclosure has verified the validity of the control device 100 according to the present example embodiment by simulation. As simulation conditions, the vehicle speed v was set to 60 km/h, and the steering frequency was set to 0.25 Hz. FIG. 9 illustrates graphs of steering characteristics as simulation results. The horizontal axis represents the steering angle, and the vertical axis represents the steering torque. A waveform indicated by a broken line indicates a steering characteristic in a case where the SAT compensation was not applied, and a waveform indicated by a solid line indicates a steering characteristic in a case where the SAT compensation was applied.

From the simulation results, it can be seen that the hysteresis width of the steering angle is improved by applying the SAT compensation. Specifically, the hysteresis width in the case where the SAT compensation was not applied was 16 deg, and the hysteresis width in the case where SAT compensation was applied was 10 deg. In such a steering angle range, typically, it is difficult to recognize a steering wheel center position from steering torque information, and the vehicle is likely to deviate. Therefore, the hysteresis width of the steering angle is preferably narrow. The range in which it is difficult to recognize the steering wheel center position is a residual steering wheel angle at which the steering wheel does not return to the steering wheel center position by the self-aligning torque, and the driver needs to intentionally return the steering wheel. Therefore, the assist torque for assist in the direction of returning the steering wheel is generated by the SAT compensation and the active return to reduce the residual steering wheel angle in the present example embodiment.

Example embodiments of the present disclosure may be applicable to a control device for controlling an electric power steering apparatus mounted in a vehicle.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-17. (canceled)

18. A control device that is usable in an electric power steering apparatus including a motor and a deceleration gear and configured or programmed to control driving of the motor, the control device comprising:
a processor; and
a memory that stores a program controlling an operation of the processor to cause the processor to:
acquire a steering torque detected by a steering torque sensor, a vehicle speed detected by a vehicle speed sensor, a steering angle detected by a steering angle sensor, and a rotational speed of the motor;
generate a base assist torque based on the steering torque and the vehicle speed;
generate a self-aligning torque compensation torque based on the steering torque, the vehicle speed, the rotational speed of the motor, and the base assist torque;
generate an active return torque based on the vehicle speed and the steering angle;
generate a motor loss torque compensation torque based on the rotational speed of the motor; and
generate a torque command value to be used to control driving of the motor based on the base assist torque, the self-aligning torque compensation torque, the active return torque, and the motor loss torque compensation torque.

19. The control device according to claim 18, wherein
the program causes the processor to:
generate a stabilization compensation torque by using a stabilization compensator based on the base assist torque and the self-aligning torque compensation torque; and
generate the torque command value based on the active return torque, the motor loss torque compensation torque, and the stabilization compensation torque.

20. The control device according to claim 19, wherein
the processor generating the self-aligning torque compensation torque includes estimating a self-aligning torque compensation torque T_{SAT} based on a following formula:
T_{SAT}=Tₜₒᵣ+g_{c}*T_{BASE}−T_{fric},
where Tₜₒᵣ represents the steering torque, g_{c} represents a gear ratio of the deceleration gear, T_{BASE} represents the base assist torque, and T_{fric} represents a friction torque.

21. The control device according to claim 20, wherein
the processor is configured or programmed to refer to a table that defines a correspondence between the friction torque and the rotational speed of the motor, and determine the friction torque based on the rotational speed of the motor.

22. The control device according to claim 21, wherein
the processor is configured or programmed to refer to another table that defines a correspondence between a self-aligning torque gain and the vehicle speed, and determine the self-aligning torque gain based on the vehicle speed; and
the estimated self-aligning torque is multiplied by the self-aligning torque gain to correct the self-aligning torque in accordance with the vehicle speed, and a corrected self-aligning torque is generated.

23. The control device according to claim 22, wherein
the processor is configured or programmed to apply first-order phase lag compensation to the corrected self-aligning torque to generate the self-aligning torque compensation torque.

24. The control device according to claim 18, wherein
the processor is configured or programmed to refer to a table that defines a correspondence between a loss torque of the motor and the rotational speed of the motor, determine the loss torque of the motor based on the rotational speed of the motor, and apply first-order phase lag compensation to the determined loss torque of the motor to generate the motor loss torque compensation torque.

25. The control device according to claim 18, wherein the processor is configured or programmed to generate a current command value based on the torque command value, and control driving of the motor based on the current command value.

26. An electric power steering apparatus comprising:
a motor;
a steering torque sensor;
a steering angle sensor; and
the control device according to claim 18.

27. A control method, usable in an electric power steering apparatus including a motor and a deceleration gear and configured to control driving of the motor, the control method comprising:
acquiring a steering torque detected by a steering torque sensor, a vehicle speed detected by a vehicle speed sensor, a steering angle detected by a steering angle sensor, and a rotational speed of the motor;
generating a base assist torque based on the steering torque and the vehicle speed;
generating a self-aligning torque compensation torque based on the steering torque, the vehicle speed, the rotational speed of the motor, and the base assist torque;
generating an active return torque based on the vehicle speed and the steering angle;
generating a motor loss torque compensation torque based on the rotational speed of the motor; and
generating a torque command value to be used to control driving of the motor based on the base assist torque, the self-aligning torque compensation torque, the active return torque, and the motor loss torque compensation torque.

28. The control method according to claim 27, further comprising:
generating a stabilization compensation torque by using a stabilization compensator based on the base assist torque and the self-aligning torque compensation torque; wherein
the torque command value is generated based on the active return torque, the motor loss torque compensation torque, and the stabilization compensation torque.

29. The control method according to claim 28, wherein
the generating the self-aligning torque compensation torque includes estimating a self-aligning torque compensation torque T_{SAT} based on a following formula:
T_{SAT}=Tₜₒᵣ+g_{c}*T_{BASE}−T_{fric},
where Tₜₒᵣ represents the steering torque, g_{c} represents a gear ratio of the deceleration gear, T_{BASE} represents the base assist torque, and T_{fric} represents a friction torque.

30. The control method according to claim 29, wherein
the friction torque is determined based on the rotational speed of the motor by referring to a table that defines a correspondence between the friction torque and the rotational speed of the motor.

31. The control method according to claim 30, wherein
a self-aligning torque gain based on the vehicle speed is determined by referring to another table that defines a correspondence between the self-aligning torque gain and the vehicle speed; and
the estimated self-aligning torque is multiplied by the self-aligning torque gain to correct the self-aligning torque in accordance with the vehicle speed, and a corrected self-aligning torque is generated.

32. The control method according to claim 31, wherein
the self-aligning torque compensation torque is generated by applying first-order phase lag compensation to the corrected self-aligning torque.

33. The control method according to claim 27, wherein
the motor loss torque compensation torque is generated by referring to a table that defines a correspondence between a loss torque of the motor and the rotational speed of the motor, determining the loss torque of the motor based on the rotational speed of the motor, and applying first-order phase lag compensation to the determined loss torque of the motor.

34. The control method according to claim 27, further comprising:
generating a current command value based on the torque command value, and controlling driving of the motor based on the current command value.
